(19) United States
(12) Patent Application Publication
(10) Pub. No.: US 2011/0177732 A1
(43) Pub. Date: Jul. 21, 2011

(54) COLD WATER SURVIVAL APPARATUS

(75) Inventor: Graham Scott Clifford, Ontario (CA)

(73) Assignee: COLD WATER SURVIVAL CANADA INC., Dundas (CA)

(21) Appl. No.: 12/689,705

(22) Filed: Jan. 19, 2010

(51) Int. Cl. B63B 35/58; B63C 9/087; B63C 9/04; A62B 17/00

(52) U.S. Cl. 441/38; 441/42; 441/103; 2/456

(57) ABSTRACT

Apparatus for helping a person survive on a cold body of water includes a suit capable of covering at least a substantial portion of the user's body while allowing the user to move and work out of water. An inflatable raft is provided to hold and support the person on water when the raft has been inflated. The raft in a deflated state is foldable into a compact configuration and is sufficiently light in weight to be carried on a back of the person out of water. There is a raft holder adapted to hold the raft in its compact state and adapted for carrying on the suit. The raft can be tethered to the suit or the raft holder.

### BACKGROUND

This invention relates to cold water survival suits and life rafts.

Survival (or immersion) suits are known in the prior art and are commonly found, for example, on fishing vessels, to protect fisherman from the effects of cold water exposure should they go overboard. However known suits are normally only suitable for keeping a person warm for a relatively short period of time, which may be insufficient to permit rescue.

Inflatable rafts are known and are in common use, including rafts which will inflate automatically. One such inflatable raft is packed in a separable, two-piece rigid container. In order to deploy this known raft, the container is tossed into the water and a lanyard extending from the raft is yanked to activate a carbon dioxide cylinder valve to inflate the raft. Inflation will then enlarge the raft to separate the container sections and release the raft ready for use.

### SUMMARY OF THE INVENTION

Forming one aspect of the invention is apparatus for use by a person required to work in conditions which expose the person to a threat of immersion in a cold water body. This apparatus comprises a raft and a raft holder. The raft has: an inflated state in which it, in use, floats atop said water body and holds and supports said person above said water body; and a deflated state in which it can be packed into a compact configuration. The raft holder, in use, is carried on the back of said person and is adapted to hold said raft when in said compact configuration.

According to other aspects of the invention, the apparatus can further comprise a survival suit which, in use, covers at least a substantial portion of the body of said person while allowing said person to perform said work at least when out of said water body, and to move and swim when in said water body. The suit can be buoyant in said water body.

According to another aspect of the invention, the apparatus can further comprise a tether in the form of a flexible line which is adapted to operatively couple the raft to the raft holder.

According to another aspect of the invention, the apparatus can further comprise a tether in the form of a flexible line which is adapted to couple the raft either to the raft holder or the survival suit.

According to another aspect of the invention, said raft, when inflated and in use, can: be circular in top plan view; have an annular tube portion floating on the water body; have upper and lower flexible layers, each of said upper and lower layers being connected to said tube portion, the upper layer supporting said person above said lower layer and above the water body, and include a substantially conical cover portion operatively connected to said layers to form a substantially conical chamber containing said person.

According to another aspect of the invention, the lower layer can be imperforate and seal the opening defined by the tube portion.

According to another aspect of the invention, the upper layer can be at least substantially imperforate.

According to another aspect of the invention, the lower layer can have a flexible line extending therefrom, through the upper layer, and the upper layer can have a clamp for releasably, securely receiving the flexible line, to permit the lower layer to present a downwardly-facing, generally concave surface.

According to another aspect of the invention, the raft can comprise a system for causing said raft to assume the inflated state in said water body.

According to another aspect of the invention, the system can comprise a supply of pressurized gas which is released to cause the raft to assume the inflated state.

According to another aspect of the invention, the system can comprise a valve system which automatically releases the pressurized gas when exposed to said water body; and the valve system can be positioned on the raft to permit it to be exposed to said water body when the raft is released from the raft holder.

According to another aspect of the invention, the raft holder can have a rip cord for releasing the raft.

According to another aspect of the invention, the raft holder can be integrally connected to the survival suit.

According to another aspect of the invention, the cover portion can include inner and outer walls, sealed to one another to form a bladder which, when inflated, causes the cover portion to assume said substantially conical shape.

According to another aspect of the invention: the valve system can comprise one or more valves, each of said one or more valves, in use, being immersed in the water body on the underside of the tube portion; each of said one or more valves can form part of a respective compressed gas inflator; and a tube system can be coupled to each of said one or more valves, the tube system including tubing which leads from said one or more valves to the interior of the tube portion and the bladder, the tubing having perforations through which the compressed gas enters the tube portion and the bladder.

According to another aspect of the invention, each inflator can be supported in use otherwise than by the valve so as to avoid fatigue at the seal which could otherwise result in leakage.

According to another aspect of the invention, each inflator can include a replaceable compressed gas canister.

These and, other aspects of the disclosed apparatus will become readily apparent to those having ordinary skill in the art from the following detailed description taken in conjunction with the accompanying drawings, the latter being described hereinafter.

### BRIEF DESCRIPTION OF THE DRAWINGS

FIG. 1 is a perspective view of a person fitted with apparatus according to an exemplary embodiment of the present invention, this view showing the front and right side, with a throat zipper shown closed;

FIG. 2 is a rear view of the subject of FIG. 1;

FIG. 3 is an enlarged view of encircled area 3 of FIG. 1, with the throat zipper shown open position;

FIG. 4A is an enlarged view of encircled area 4A of FIG. 1;

FIG. 4B is a view similar to FIG. 4A with a zipper fastener revealed;

FIG. 4C is a view similar to FIG. 4B with the zipper fastener separated and a glove part separated from a sleeve portion of the suit;

FIG. 4D is a view similar to FIG. 4C, with the glove part of FIG. 4C secured to the sleeve portion of FIG. 4C by a hook and loop fastener;

FIG. 5A is an enlarged view of encircled area 5A of FIG. 1;

FIG. 5B is a view similar to FIG. 5A with a zipper fastener revealed;

FIG. 5C is a view similar to FIG. 5B with the zipper fastener separated and a boot part separated from a leg portion of the suit;

FIG. 5D is a view similar to FIG. 5C, with the boot part of FIG. 5C secured to the leg portion of FIG. 5C by a hook and loop fastener;

FIG. 6 is a view similar to FIG. 2 showing the holder in the release position;

FIG. 7 is a view similar to FIG. 6, with a raft being withdrawn out of the holder;

FIG. 8 is a view similar to FIG. 7, with the holder emptied;

FIG. 9 is a view similar to FIG. 7, with the person immersed in a body of water and the raft to one side and in a deflated configuration;

FIG. 10 is a view similar to FIG. 9, with the raft in the process of inflation;

FIG. 11 is a view similar to FIG. 10 showing the raft in the inflated configuration, with the access door secured closed;

FIG. 12 is a view similar to FIG. 11, with the access door open and showing the person in the process of entering the raft;

FIG. 13 is a view similar to FIG. 12, with the access door closed and the person, illustrated in phantom, sitting in the raft and gripping the handles;

FIG. 14 is a view showing FIG. 2 in combination with a raincoat, boots and gloves;

FIG. 16 is a view along section 16-16 of FIG. 15;

FIG. 17 is a side view of encircled structure 17 of FIG. 16;

FIG. 18 is an enlarged view of encircled structure 17 of FIG. 16;

FIG. 19 is a view of encircled structure 19 of FIG. 16;

FIG. 20 is a top view of FIG. 19;

FIG. 21 is a left view of FIG. 19;

FIG. 22 is a front view of FIG. 19;

FIG. 23 is a right view of FIG. 19;

FIG. 24 is a rear view of FIG. 19;

FIG. 25 is a schematic view of an alternate embodiment of the structure identified with bracket 25 of FIG. 16, showing how a flexible line can be used to adjust the shape of the bottom of the life raft;

FIG. 26 is a partial view along section 26-26 of FIG. 25, showing a clamp portion in a closed position;

FIG. 27 is a view similar to FIG. 26, showing the clamp portion in an open position; and

FIG. 28 is a view similar to FIG. 11 showing another exemplary embodiment of the present invention.

### DETAILED DESCRIPTION

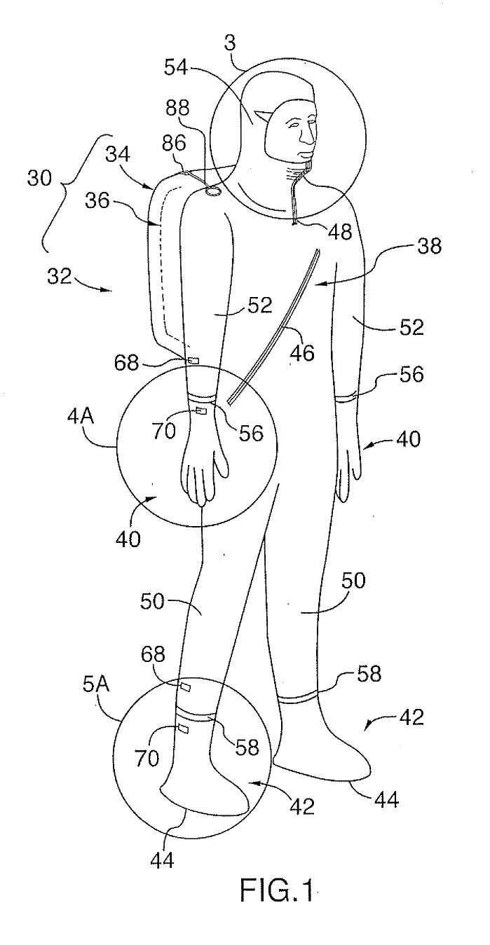

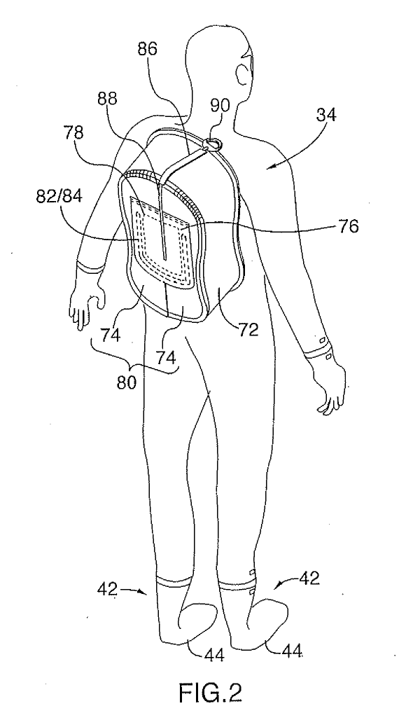

A person wearing an exemplary embodiment of apparatus 30 according to the present invention is shown in FIG. 1 and will be seen to include, as main components, a suit 32, a raft holder 34 and, in phantom, an inflatable raft 36. Each of these components are discussed in more detail below, but as an initial matter, it will be understood that raft 36 and raft holder 34 are sufficiently light-weight and, as shown in FIG. 1, compact, and the suit 32 is sufficiently flexible, form-fitting and light-weight, to enable the user to move and to work and to carry on other activities out of water, for example on the deck of a boat such as fishing vessel. Also, if the person is forced to jump into or is otherwise immersed into a cold body of water, movement and swimming in the water will be possible.

The illustrated and exemplary suit 32 will be seen to include a main part 38, a pair of glove parts 40 and a pair of boot parts 42. The main part 38 covers the trunk, legs and arms of the user, and all of the head of the user but for a section of the face including the eye area. The glove parts 40 cover the user's hands and the boot parts 42 cover the user's feet.

The boot parts 42 have ribbed undersides 44, to provide traction to the wearer, for example, on the deck of a fishing vessel; the boot parts 42 will also be understood to protect the feet of a user in the manner of conventional work boots.

The main part 38 is provided with a diagonally extending, waterproof zipper 46 which extends across the chest area from one shoulder to about the waistline, and a vertically extending, waterproof throat zipper 48 is provided.

It will be understood that with zippers 46,48 open, a person will be able to introduce his or her legs into and through the legs 50 of the suit and into the boot parts 42, his or her arms into and through the arms 52 of the suit and into the glove parts 40, and his or her head into the head 54 of the suit, as shown in FIG. 1.

Wrist 56 and ankle 58 extensions are provided, at the junctions of the main part 38 of the suit with the glove 40 and boot 42 parts. These extensions 56,58 take the form of neoprene tubes joined by ultrasonic welding to the glove 40 and boot 42 parts which can be withdrawn, as shown by the sequences of 4A,4B and 5A,5B, to reveal waterproof zippers 60,62. The extensions 56,58, when drawn over zippers 60,62, provide a further watertight seal, and also protect zippers 60,62 against damage and unintended operation.

The zippers 60,62 removably join the glove 40 and boot 42 parts to the main part 38.

As indicated by sequences 4B,4C and 5B,5C, the glove 40 and boot 42 parts can be unzipped and removed from the main part 38, and removed from the feet and hands of the person, when he or she is resting or otherwise not in need of the protection/comfort afforded by these parts of the suit.

So as to avoid loss of the glove 40 and boot 42 parts, strap connectors 64,66 are provided for each of the glove 40 and boot 42 parts, these connectors 64,66 being non-removably connected to secure its respective glove 40 or boot 42 to an adjacent surface of the main part 38 of the suit when the glove 40 or boot 42 part has been unzipped and removed from a respective hand or foot of the user.

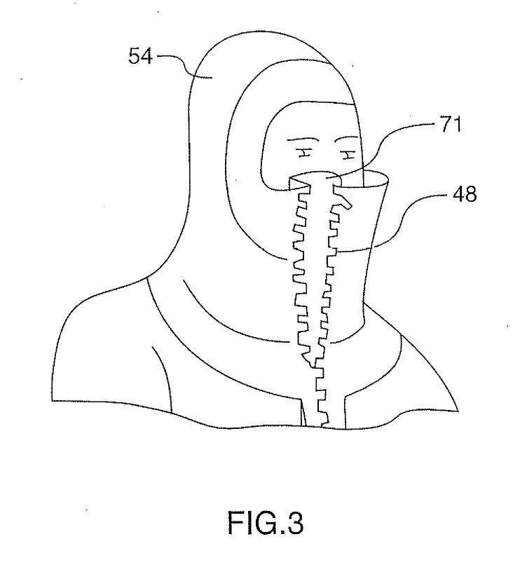

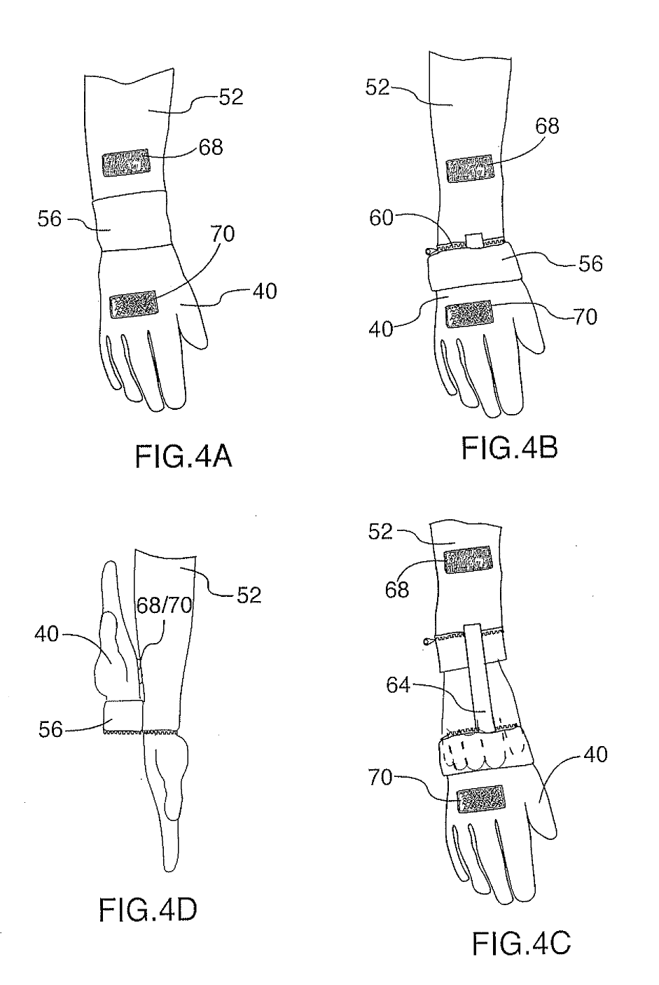

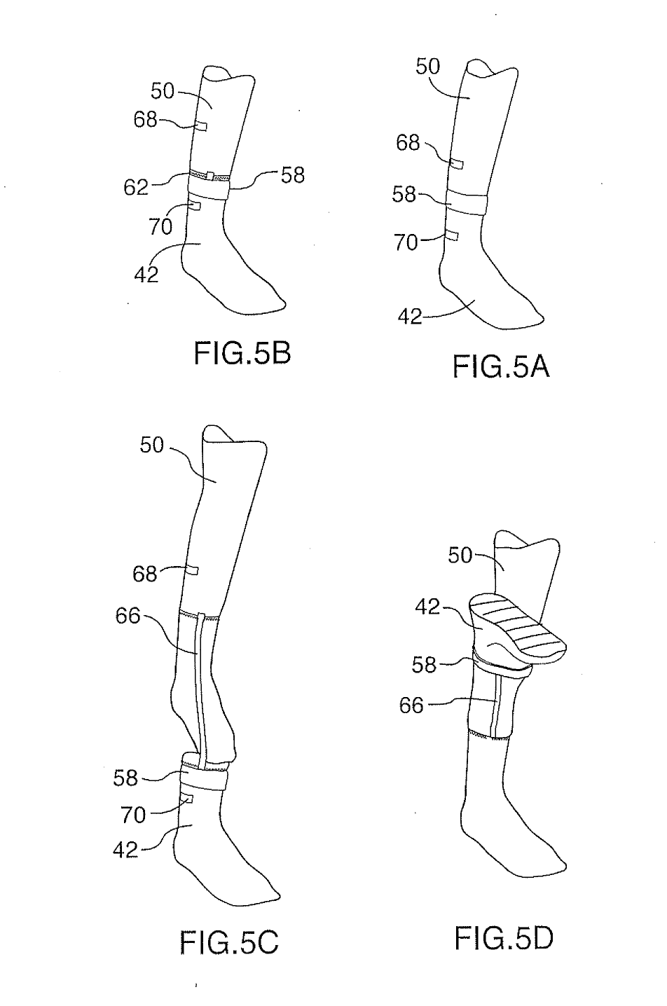

Hook 68 and loop 70 strip connectors are secured to each of the glove 40 and boot 42 parts, and to adjacent arm 52 and legs 50 of the suit, so that, when a glove 40 or boot 42 part has been removed, it can be secured against dangling, as indicated by FIGS. 4D and 5D.

The throat region of the suit 12 is illustrated open in FIG. 3, wherein it will be seen that an extra V-shaped piece of material 71 is provided which extends the length of the throat zipper 48 and tapers downwardly. Each vertical edge of this strip 71 of material is attached to a respective side of the opening created by unzipping the zipper 48. When the zipper 48 is closed, the neck area of the user is substantially sealed from the ingress of water. Material 71 protects the neck of the user from the throat zipper 48.

The precise manner of construction of the suit 32 is not detailed herein, as (i) the manner in which suits of this type are constructed is well-known to persons of ordinary skill in the art and (ii) the suit will be constructed in a manner which is dependent to some extent on the water temperatures and working conditions likely to be encountered by the user. However, generally, it will be understood that the suit 32 will be constructed in the manner of a survival suit, of the type worn, for example, by fishermen when working on deck in cold water conditions. In some applications, 4.5-5.0 mm neoprene foam will be useful for the construction of the main part, the glove parts and the uppers of the boot parts. A suitable foam is Double Cell L Foam sold by Macro International Company.

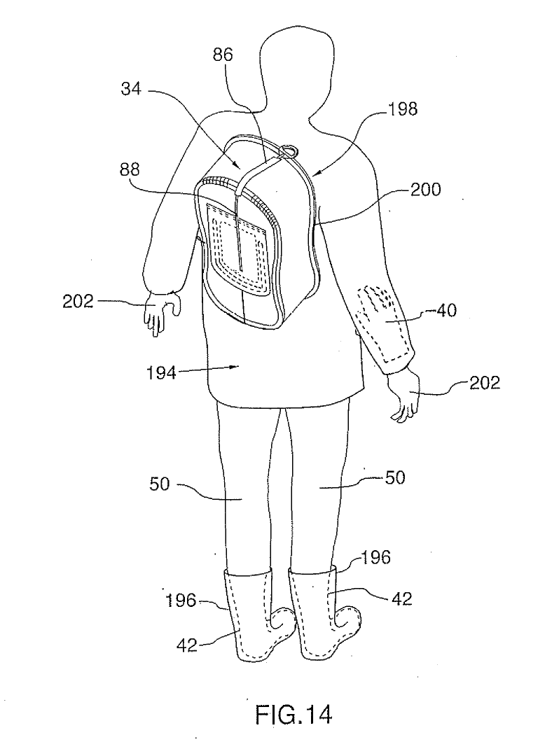

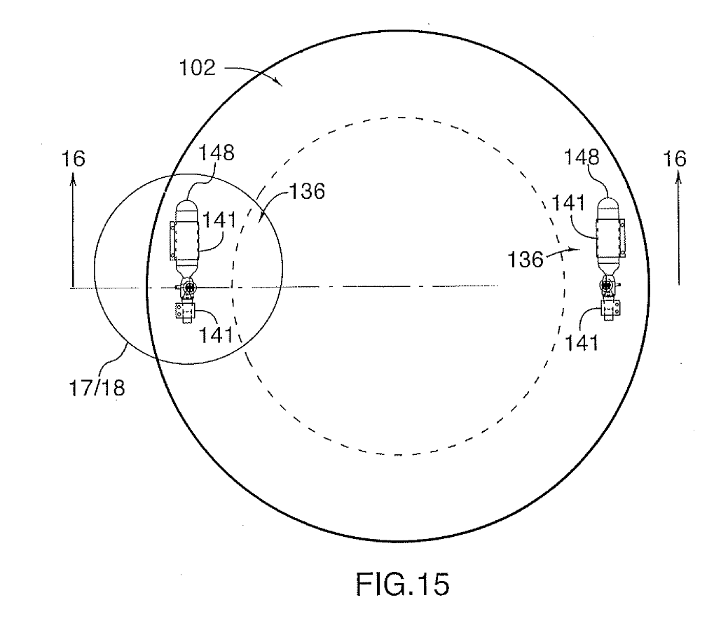

It is contemplated that the suit 32 will normally be worn as shown in FIG. 14. In this illustration, it will be seen that the suit 32 is worn underneath a raincoat 194 and oversized conventional boots 196. A suitable material for the raincoat 184 is PVC-coated cotton. The raincoat 194 has an aperture 198, with an elastic binding 200, through which the raft holder 34 can protrude, so as to maintain comfort. Conventional work gloves 202 are also used, with the glove parts 40 of the suit concealed within the sleeves of the suit as indicated in FIG. 4D. This arrangement protects the suit 32 from wear, pin-holing, etc., that might otherwise relatively quickly occur in use; the coat 194, boots 196 and gloves 202 can be selected by the user for the task at hand, and discarded once worn, as is conventionally done. The coat 194, boots 196 and gloves 202 will normally be discarded in the case of immersion. This will preferably occur prior to immersion, i.e. in circumstances wherein co-workers can readily help one another remove gloves, boots and jackets, but this can also take place following immersion. Although not shown, it will also be understood that engineered garments can and will normally be worn under the suit as well, for enhanced comfort and protection. The nature of these under-suit garments is obvious to persons of ordinary skill and is not detailed herein for this reason.

Turning now to the construction of the holder 34 and with reference to FIGS. 1,2, the illustrated holder 34 is in the form of a back pack adapted to hold the raft 36 in a compact configuration. In the exemplary and illustrated embodiment, the holder 34 comprises a sidewall 72, a pair of rear flaps 74 and a cover flap 76.

The sidewall 72 and the rear flaps 74 are secured to the back of the suit to define a compartment having a rear aperture (78, indicated in phantom) and a split rear wall 80, and the cover flap 76 overlies the aperture 78 and is secured to the rear wall 80 by a horseshoe-shaped hook 82 and loop 84 fastener set (shown in phantom). The aperture 78 occupies substantially all of the rear wall 80 but for that portion occupied by the hook 82 and loop 84 fastener, so as to maximize the size of the opening 78.

The manner of construction of a structure of this type is a manner of routine to persons of ordinary skill. Accordingly, details of construction are neither required nor provided. However, one possible methodology of construction involves double scrim Thinsulate™ laminated under pressure between Duralar™ plastic sheeting, and secured by stitching to a layer of 11.5 oz marine polyester.

This structure can be cut, press-formed, stitched and glued to form the sidewalls and rear flaps. The cover flap can also be constructed out of 11.5 oz marine polyester and stitched to the rear wall. Importantly, the backpack will be contoured, so as to avoid snags with doorways and the like, and for general user comfort while working and at rest.

A rip cord arrangement is also provided, and includes a tube of nylon fabric 86 traversing the shoulder of the suit, and a nylon-coated stainless steel wire 88 extending from the free end of the cover flap 76 to a two-finger pull handle 90 disposed on the shoulder of the suit. Again, numerous variations on this structure will be routine to persons of ordinary skill, but Delrin™ is noted to be a possible substrate for the pull handle 90.

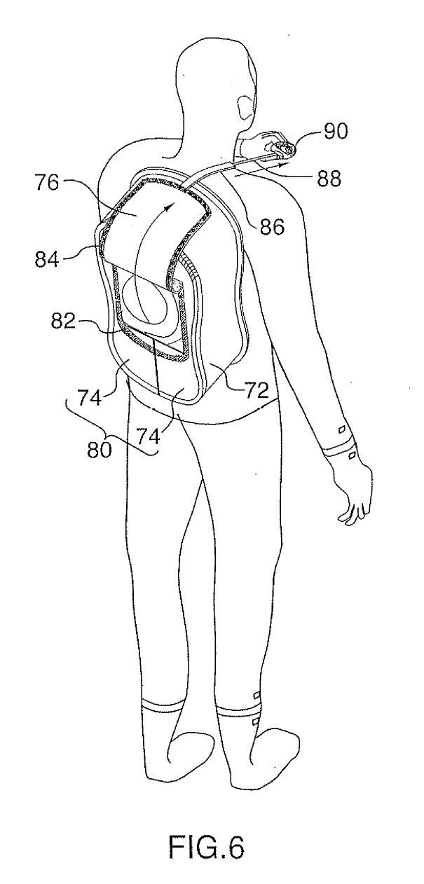

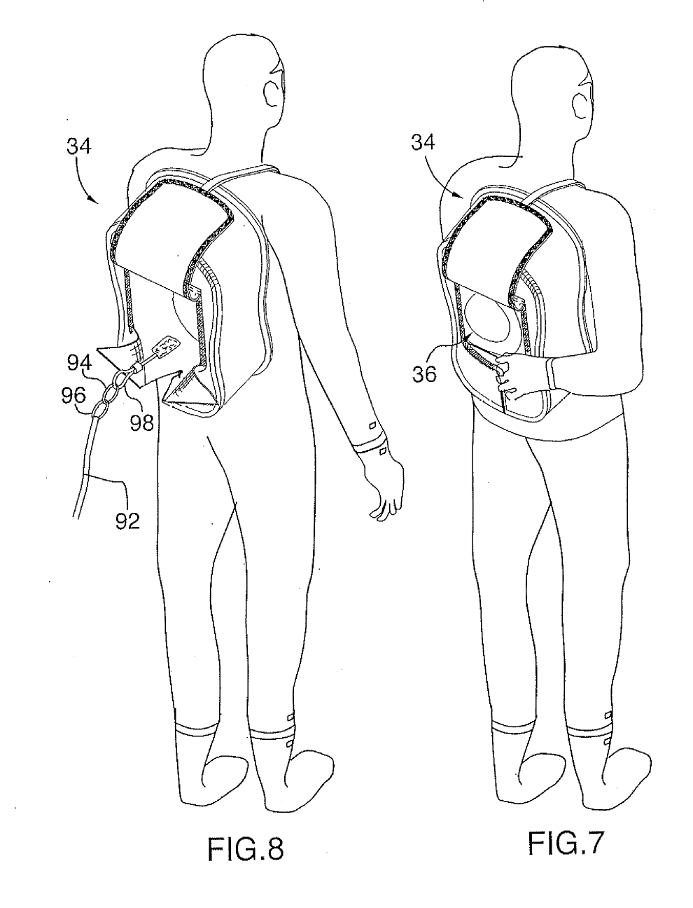

In the event that the user of the suit wishes to gain access to the raft 36, he or she pulls the handle 90, as indicated by FIG. 6. This causes the hook 82 and loop 84 fastener to release, and separates the cover flap 76 from the rear flaps 74, to release the raft 36; the user may reach behind his or her back, to pull the raft from the holder, as indicated by FIG. 7, but this will not always or usually be required.

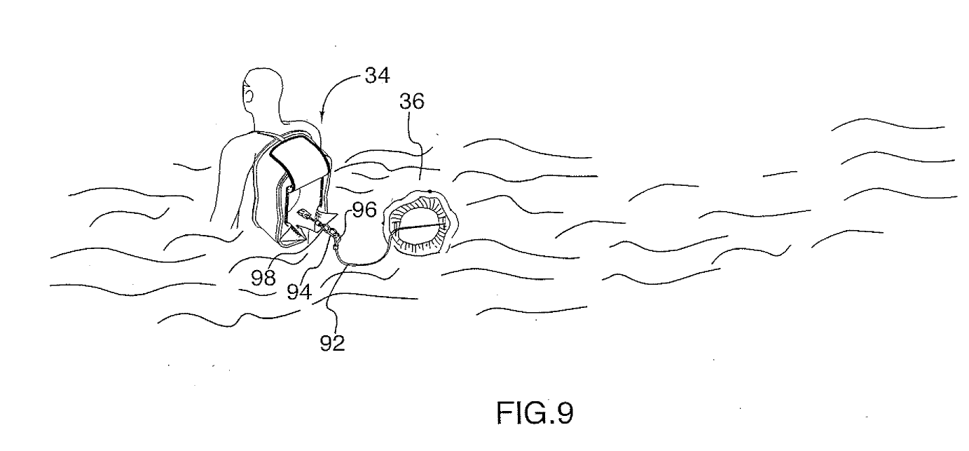

As indicated by FIGS. 8-9, the raft 36 is tethered to the holder 34 (and thus indirectly to the suit 32) by a length of ⅛″ marine cord 92. It will be understood the purpose of the tether line 92 is to prevent the user from being separated from the raft 36, which might otherwise occur in rough seas. The tether 92 could equally be tethered directly to the suit.

As shown in FIG. 8, the tether 92 is attached to the inside of the holder 34 by means of carabiner 94 which secures an eye connector 96 of the tether line 92 to a swivel connector 98 secured to the interior of the holder 34.

The user is able to unclip the tether line 92 from the holder 34 by reaching towards the back of the suit and disconnecting the carabiner 94. The other end of the tether line 92 is connected to the raft 36 by another eye connector 96/carabiner 94/swivel hook 98 combination. This helps prevent entanglement and twisting of the line.

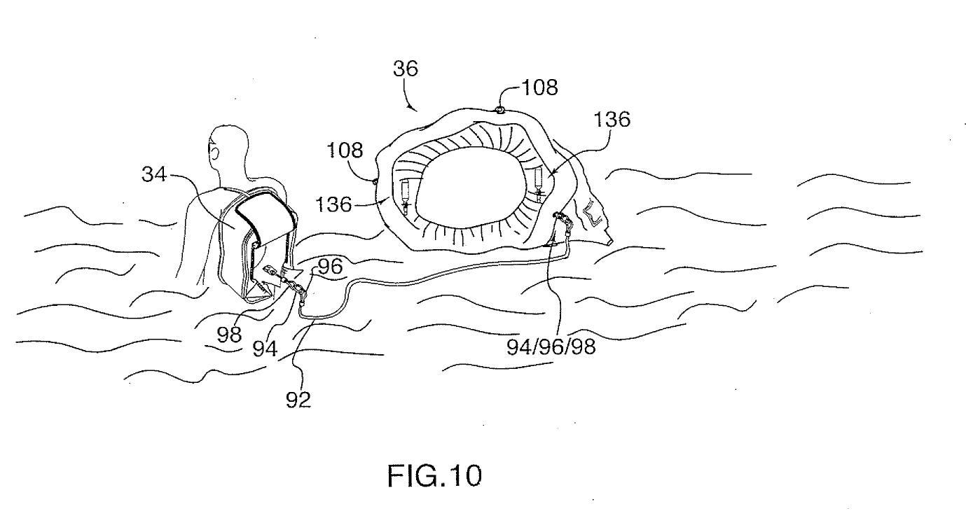

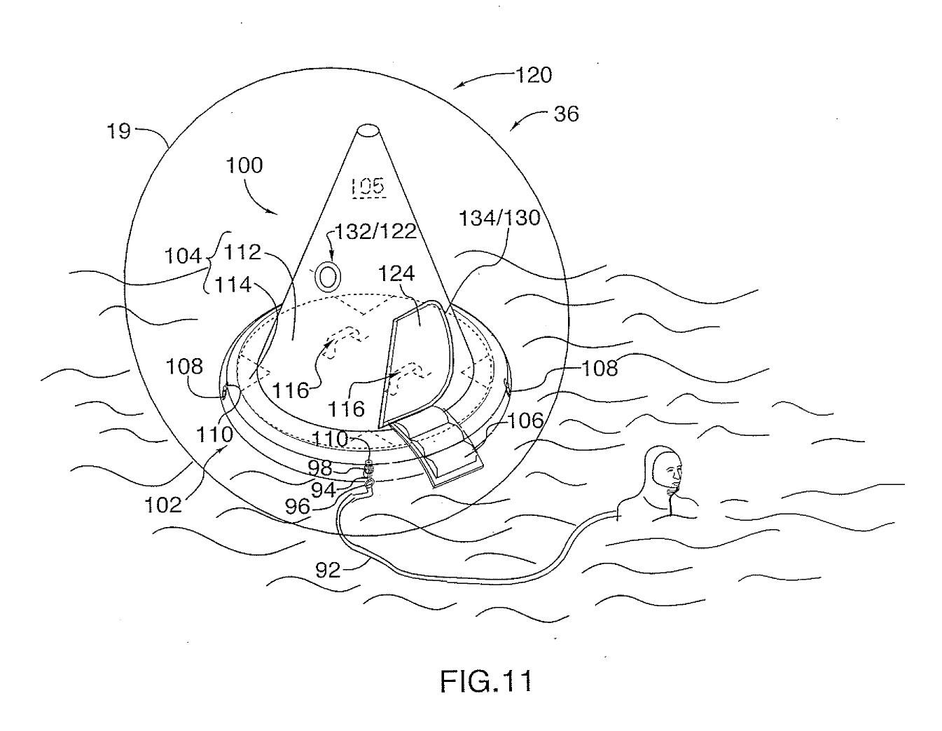

With the release of the raft 36 from the holder 34 into a body of cold water, a compressed gas system, detailed in further paragraphs, will cause the raft to become inflated, as indicated by the sequence of FIGS. 9-11, the raft 36 being shown fully inflated in FIG. 11. That is, the raft 36 is of the throw-overboard type. The raft 36 itself is novel, but the construction of throw-overboard rafts is a matter of routine to persons of ordinary skill. Accordingly, details of construction are not required, nor are they provided below otherwise than as a matter of convenience in this description.

Turning now to FIG. 11, the raft 36 will seen to be circular in plan view when inflated, and composed of: a substantially conical portion 100 forming an upper portion of raft 36 in use; a tube portion 102 extending around the base of the conical portion 100; a floor portion, indicated in phantom by 104 occluding the aperture in tube portion 102 to form an interior compartment, indicated in phantom by 105; and a tongue portion 106.

The tube 102 and tongue 106 portions are made from urethane-coated rubber, welded together in a conventional manner, to form a structure which, when inflated with gas such as carbon dioxide, has sufficient buoyancy to support the conical portion 100, the floor portion 104 and the user in water. Distributed evenly about the circumference of the tube portion 102 of the raft 36 are loop connectors 108 which are firmly connected in a sealing, waterproof manner to the tube portion 102. A suitable connection methodology involves a strip of fabric 110 into which a D-ring connector 108 is sewn and which is secured through adhesive to the tube portion 102.

The floor portion 104 comprises upper 112 and lower 114 panels made out of neoprene rubber. Each of these panels 112,114 is sealingly connected about its perimeter by adhesive to the tube portion 102. The lower panel 114 is substantially imperforate, to minimize cold water infiltration into the compartment 105. The upper panel 112 is adapted to support the user above the lower panel 114 to help keep the user warm and is of cruciform shape, i.e. is defined by an open web, to minimize weight. The top surface of the upper panel 112 is provided with at least several hand holds 116. One possible method for forming hand holds 116 involves securing grommets through the upper panel 112, fitting the ends of a length of marine binding through the grommets from the topside of the upper panel, and tying knots beneath the upper panel in the ends of the binding material.

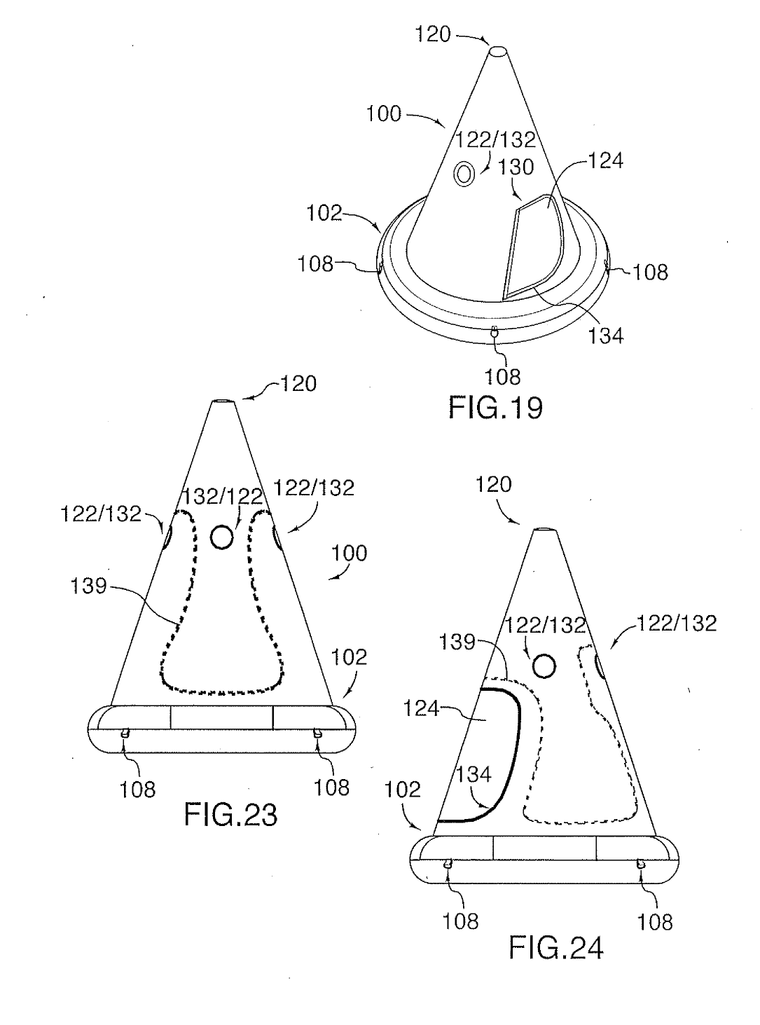

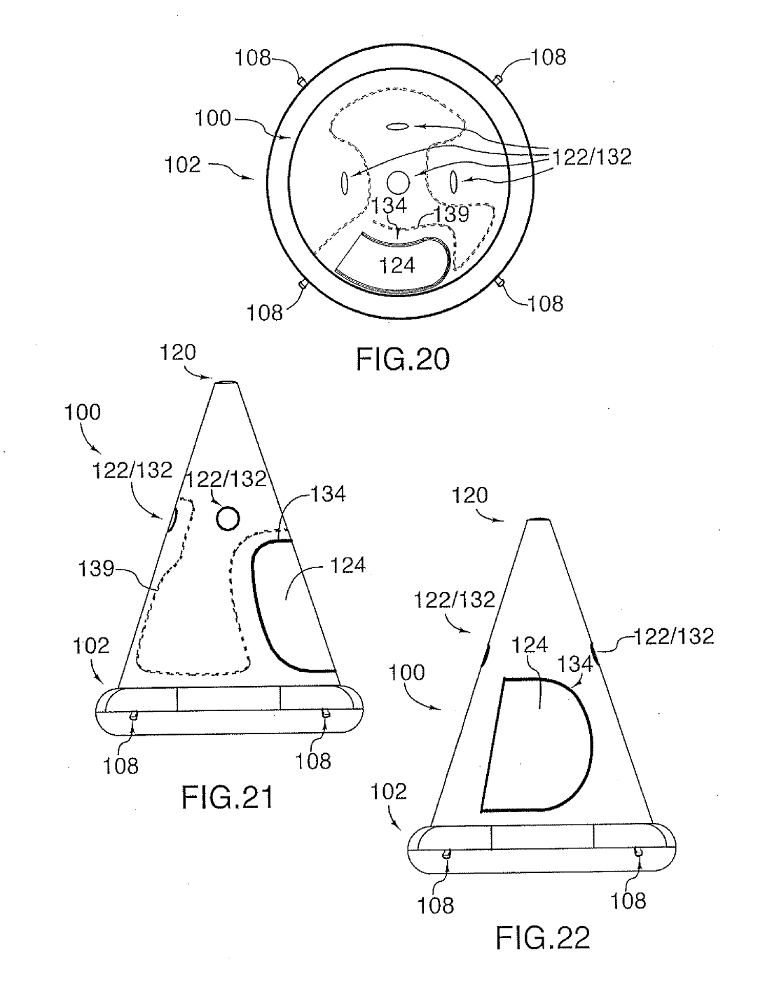

With reference to FIGS. 11, 16 and 19-24, the upper conical portion 100 of the raft has a main body 118, a dome assembly 120, windows 122 and an access panel 124.

The main body 118 is defined by inner 126 and outer 128 flexible walls, sealed to one another so as to define a bladder 129 which supports the main body 118 in a generally frustoconical shape when inflated by gas such as carbon dioxide, and are sealed to the tube portion 102 by welding or adhesive via intermediate foam rubber connector 127. The generally frustoconical shape helps prevent capsizing of the raft 36 by strong winds and waves. The shape also deters these winds from grabbing or buffeting the raft in a manner which would lift it off of the surface of the water. 840d polyurethane-coated nylon is a suitable material for construction of the inner 126 and outer 128 flexible walls; a combination of ultrasonic Welding with stitching can provide a suitable sealing methodology for rendering an airtight connection between the walls 126,128 where required for inflation.

The inner 126 and outer 128 flexible walls have defined therein an access port 130 and four window ports 132, the window ports 132 being distributed at 90° intervals around the conical shape and the access port 130 having extending thereto, in the manner of ramp, the tongue portion 106, when inflated.

The dome assembly 120 is sealed to the main body 118 by adhesive, to occlude the smaller diameter end of the main body 118; a suitable material for the dome assembly is Delrin™ plastic.

The access panel 124 is defined by an extension of one or both of the flexible walls 126,128 of the main body 118 and is shaped and dimensioned to occlude the access port 130 when operatively positioned. A waterproof zipper 134 is secured to the access panel 124 and the main body 118 and operatively positions the access panel 124 in the access port 130 when closed. The zipper 134 is accessible from both inside and outside the compartment 105. The outer zipper pull (not shown) is relatively large and reflective. A separate, much smaller zipper pull (not shown) is provided on the inner side of the zipper.

Each window 122 is defined by a layer of transparent, flexible plastic, secured by a combination of stitching and ultrasonic welding to occlude a respective window port 132. 10 mil Spec plastic is suitable for this purpose.

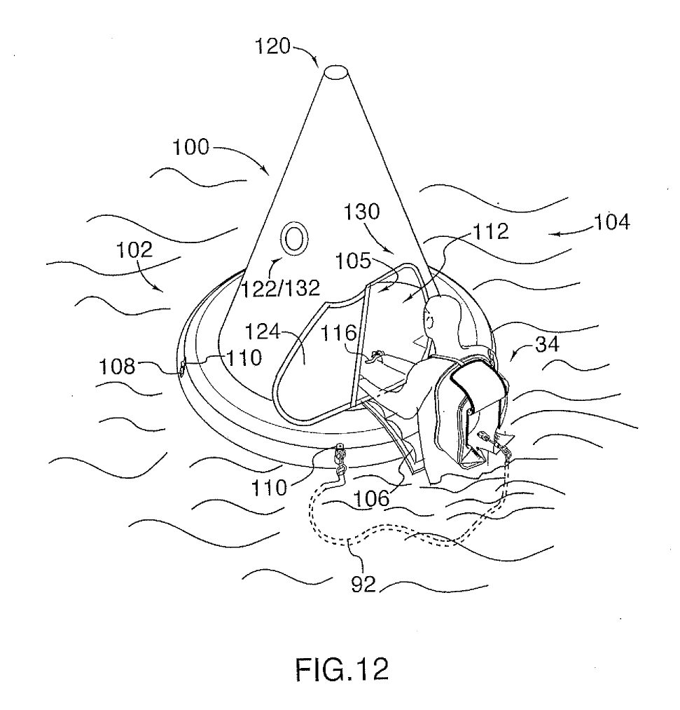

Use of the raft 36 is shown in the sequence of FIGS. 11-13, wherein it will be seen that the user can use the tether line 92 to draw him or herself and the raft 36 towards one another once in the water. The user then draws the zipper 134 on the access door 124. The large, reflective surface of the zipper pull facilitates this step. Then, using the handles 116 on the upper layer 112 of the floor 104 nearest the access port 130, draws him or herself into the compartment 105.

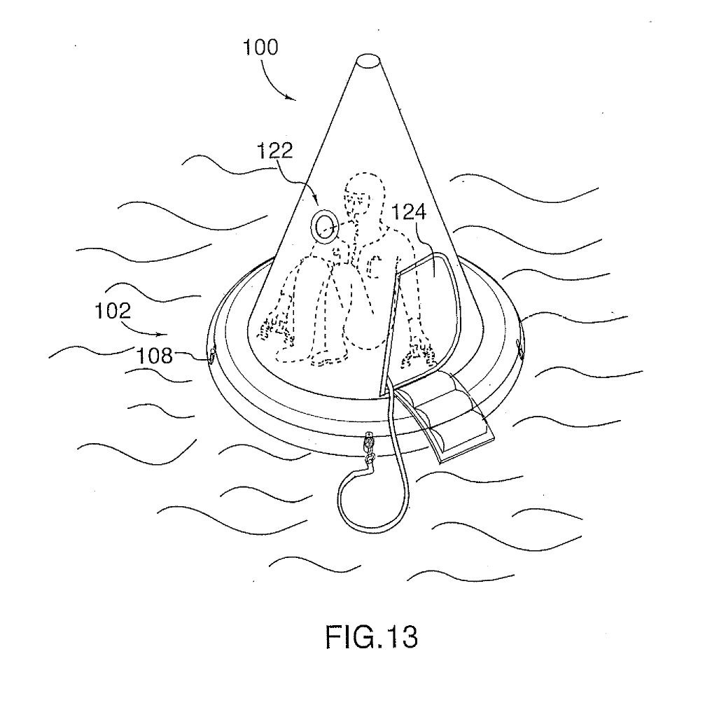

The tongue portion 106 facilitates this activity, which would otherwise be more difficult, particularly in rough seas. Once inside, with the door 124 at least partially closed, the tether line 92 can be drawn inside and disconnected, and the user can wait for rescue. In rough seas, the user may grip the handles 116 to avoid being buffeted by the waves, as shown in FIG. 13.

Where a number of users are in contemporaneous use of the apparatus 30, i.e. if the crew of a vessel were to abandon ship, a preferred outcome would be for the users to tie the rafts 36 to one another, and await rescue. This arrangement of multiple rafts 30 has advantage in terms of rescue, since the collection of rafts 30 should be more easily seen; the rescue of a group of persons from a single location, rather than a variety of locations would normally be simpler; and the presence of multiple rafts 36 tied together lessens the likelihood that all of the rafts 36 would spring leaks and sink, i.e. increases safety. A typical methodology for sea rescue involves swimmers deployed from a helicopter, and a winch-suspended basket which transports the rescuee. It is contemplated that this methodology would continue to be used in the context of the apparatus 30 of the invention.

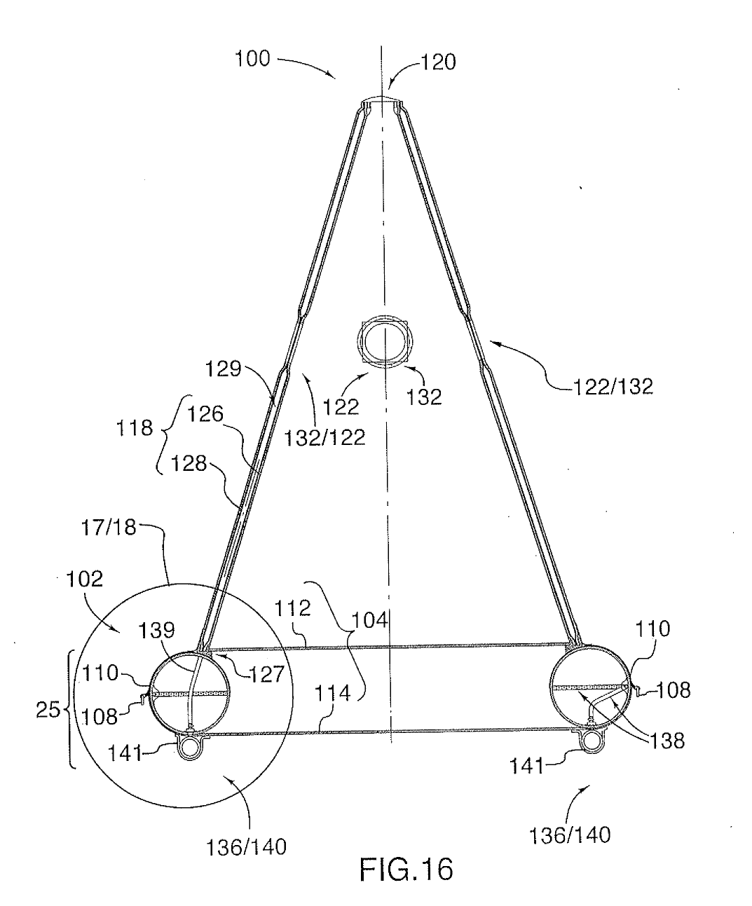

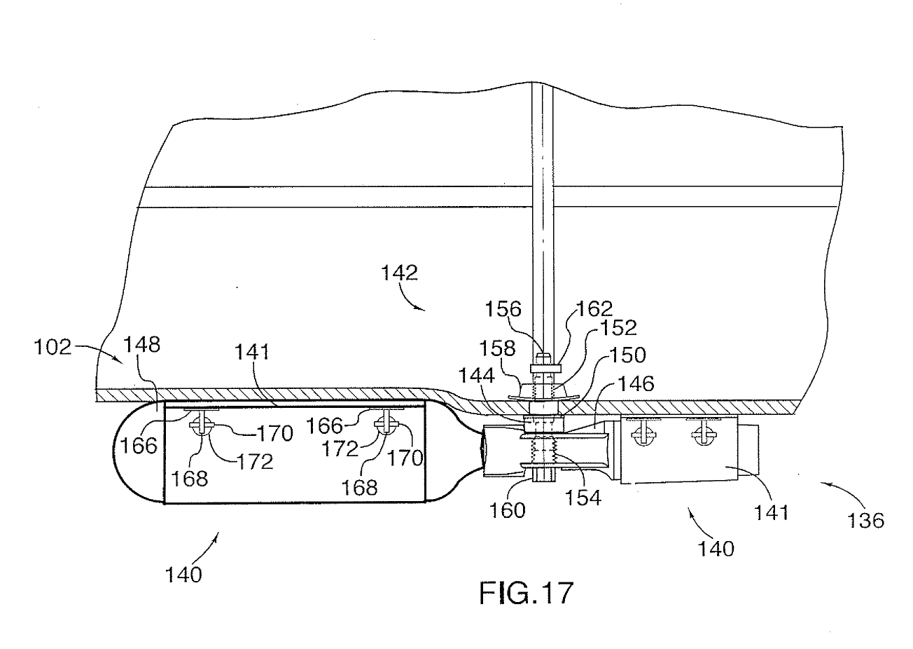

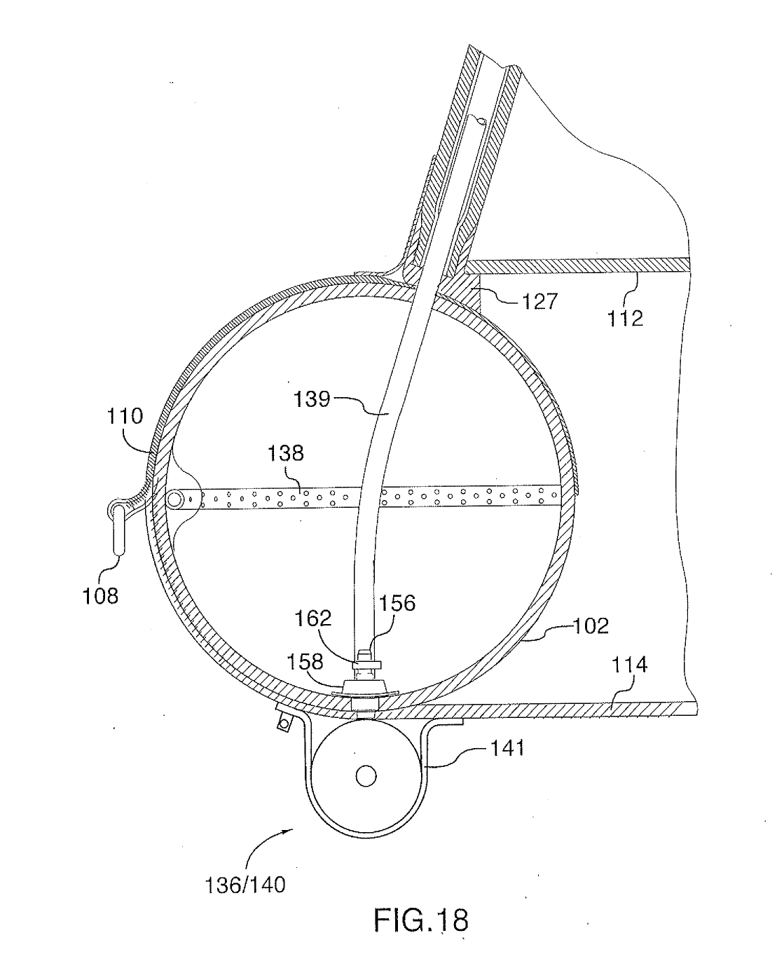

Turning now to the aforementioned compressed gas system, these are known and routine in the life raft and life preserver art, and accordingly, a detailed description is deemed unnecessary. As a matter of convenience, only, the system of the exemplary embodiment should be understood, with reference to FIGS. 16-24 to include a pair of compressed gas inflators 136, along with tubing 138,139 and slings 140.

Each inflator 136 includes a flow valve 142, a foam washer 144, an inflator body 146 and a compressed gas bottle 148. A suitable inflator body 146 is sold under the trade-mark PROSENSOR by United Moulders Limited UK. The flow valve 142 has a plastic ring 150 and threaded shafts 152,154 extending from both sides of the ring 150. A nipple 156 extends from one 152 of the threaded shafts and the other 154 threaded shaft has an aperture (not shown) through its sidewall. Two plastic nuts 158,160 are also provided.

The nipple 156 extends through a hole in the bottom wall of the tube portion 102, and the plastic ring 150 is ultrasonically welded to the surrounding part of tube portion 102, to provide a sealed connection. One of the plastic nuts 158 is threaded on the shaft 152 from which the nipple extends, to mechanically reinforce the joint, and cemented in place. The foam washer 144 is mounted over the other threaded shaft 154, followed by the inflator body 146 and then the second plastic nut 160, to secure the assembly together. The inflator body 146 communicates with the aperture in the threaded shaft, to permit gas communication. The compressed gas bottle 148 is threaded to the inflator body 146.

Each of the lengths of tubing 138,139 is crimped onto a respective nipple 156 and secured by a locking clamp 162. As indicated in FIG. 16, one of the lengths of tubing 138 passes around the inner periphery of the tube portion 102; the other length of tubing 139 leads into the bladder 129 formed in the upper portion 112. The tubing 138,139 is perforated to permit compressed gas to enter the tube portion 102 and the bladder 129. The perforated tubing ensures that the tube portion 102 and the bladder 129 are not exposed to the extreme cold that would otherwise be created at the output of the inflator [due to the expanding gases] and which could create weakness and fracture. Tubing suitable for the purpose includes that sold by Nexgen under 701-0406102; a suitable perforation protocol involves 2-2.5 mm perforations, distributed at 50 per square inch.

The slings 140 are defined in part by pieces of fabric 141. A suitable fabric is 840d polyurethane coated nylon. Two slings are provided for each inflator. Each fabric element 141 has an end secured by adhesive to the tube portion 102 and, in use, traverses underneath a respective end of a respective inflator 136, to another end which has a pair of grommets 166. The grommets 166 receive rubber stub pins 168 which protrude from and are secured by adhesive to the outer surface of the tube portion 102. Headless pins 170 extend through bores in the stub pins 168, and are secured against retraction by cable ties 172. The slings 140 support the inflators 136 against the tube portion 102 so as to avoid current-induced stresses on the valves 142 that might otherwise result in leakage.

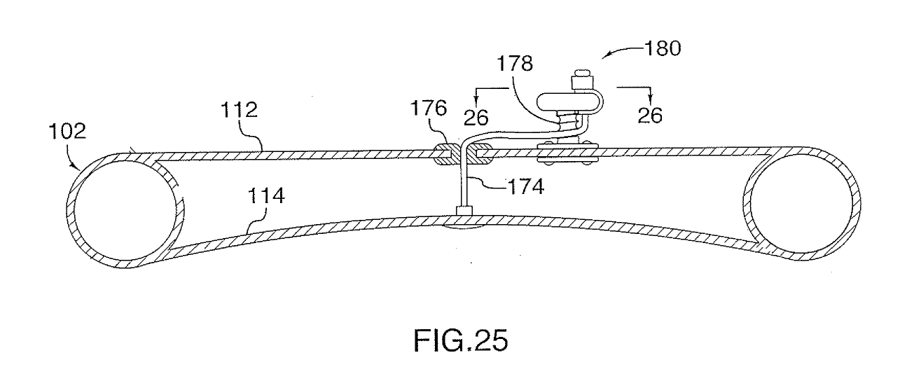

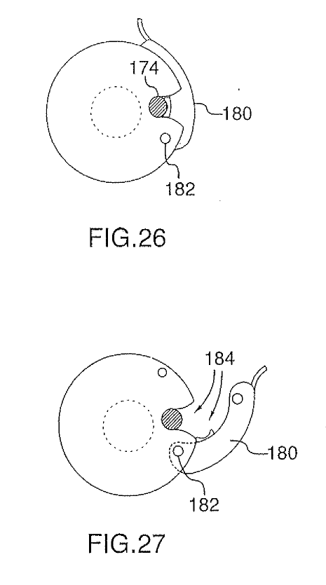

FIG. 25 shows an adjusting mechanism that can be provided with the upper 112 and lower 114 panels, to provide to the lower panel 114 a concave shape, to improve stability. In this mechanism, a lanyard line 174 is securely attached at one end to the lower panel 114 and extends through a grommet 176 mounted in the centre of the upper panel 112. The hole in the grommet 176 has rounded edges so that no catching or fraying of the lanyard line 174 occurs during use. By pulling upwardly on the line 174, the distance between the two panels 112,114 in their central regions can be reduced, thereby increasing the concavity of the lower panel 114. In order to secure the line 174 in the desired position, a plastic wrapping post 178 and a clamp member 180 are provided. The clamp member 180 is connected to the wrapping post 178 by a pivot pin 182. The lanyard line 174 can be inserted into a notch 184 in the wrapping post 178 when the clamp member 180 is in the open position shown in FIG. 27. The line 174 is secured in place by pivoting the clamp member 180 to the closed position of FIG. 26

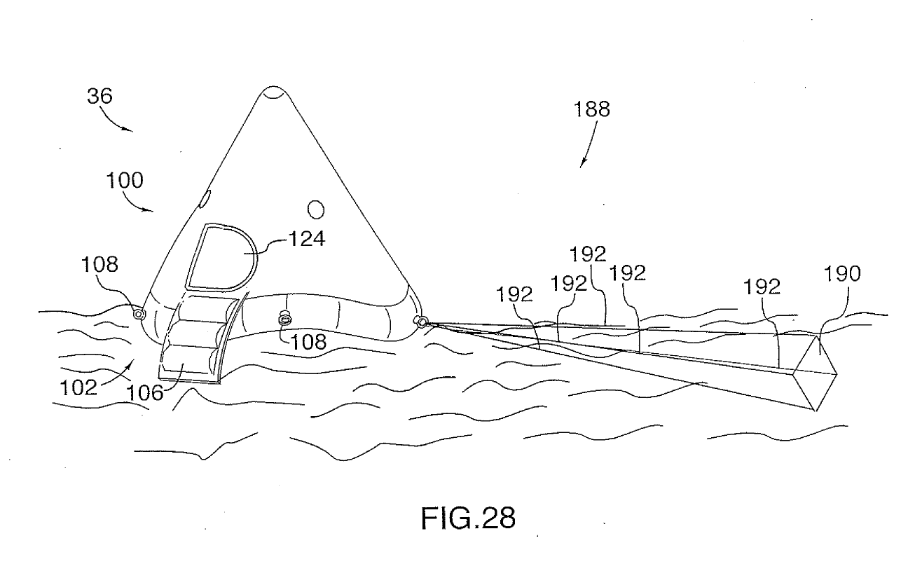

Another desirable feature for the raft is a water scoop device 188 as illustrated schematically in FIG. 28. This device 188, when released into the water, can help slow down the speed of the raft 36 in heavy water currents and can add to stability. It is anchored to the raft 36 at a location directly opposite the access port 130 to make entering the raft easier 36. The device 188 can take the form of a panel 190 of strong, flexible material such as nylon, about 18″ square. It is attached to the tube portion 102 of the raft 36 by means of strong, light nylon lines 192.

It is desirable and possibly necessary for legal purposes that the apparatus be made at least in part of or otherwise incorporate reflective and/or highly visible material. Appropriate deployment of reflective and/or highly visible material is a matter of routine to persons of ordinary skill in the art and as such further description is neither required nor provided.

While but three embodiments of the present invention are herein illustrated and described, variations are possible.

One desirable addition (not shown) is a waterproof GPS beacon, fitted in a pocket of the suit, which can be used to alert the coast guard or other emergency task forces that may be located in the area as to the existence and location of the emergency.

Another useful addition is a pump (not shown) to permit the user to inflate the life raft if the compressed gas system fails or in the event of a slow leak. In the context of the illustrated embodiment, a preferred arrangement would be a pump, coupled by a length of tubing, to the interior of the tube portion, which could be manipulated by the user from outside the raft, if necessary, and drawn inside the raft for use as necessary.

An additional desirable feature is the provision, for each air chamber, of at least one overpressure valve, to avoid the risk of over-inflation. These can be secured to the tube portion and bladder in a manner identical to the attachment of the flow valves. A suitable valve is C780RPP175 sold by Halkey-Roberts.

As well, emergency supplies will advantageously be packed in the interior of the raft. Such supplies (not shown) will include rations, a flash light, one or more de-salt tablets and sea sickness pills.

In view of these variations, and others which are possible, the invention should be understood as limited only by the accompanying claims, purposively construed.

1. Apparatus for use by a person required to work in conditions which expose the person to a threat of immersion in a cold water body, the apparatus comprising:
a raft which has
an inflated state in which it, in use, floats atop said water body and holds and supports said person above said water body; and
a deflated state in which it can be packed into a compact configuration; and
a raft holder which, in use, is carried on the back of said person and which is adapted to hold said raft when in said compact configuration.

2. Apparatus according to claim 1, further comprising:
a survival suit which, in use, covers at least a substantial portion of the body of said person while allowing said person to perform said work at least when out of said water body, and to move and swim when in said water body.

3. Apparatus according to claim 2, wherein the suit is buoyant in said water body.

4. Apparatus according to claim 1, further comprising a tether in the form of a flexible line which is adapted to operatively couple the raft to the raft holder.

5. Apparatus according to claim 2, further comprising a tether in the form of a flexible line which is adapted to couple the raft either to the raft holder or the survival suit.

6. Apparatus according to claim 1 wherein said raft, when inflated and in use,
is circular in top plan view;
has an annular tube section floating on the water body;
has upper and lower flexible layers, each of said upper and lower layers being connected to said tube section, the upper layer supporting said person above said lower layer and above the water body, and
includes a conical cover section operatively connected to said layers to form a substantially conical chamber containing said person.

7. Apparatus according to claim 6, wherein the lower layer is imperforate and seals the opening in the tube section.

8. Apparatus according to claim 7, wherein the upper layer is at least substantially imperforate.

9. Apparatus according to claim 7, wherein the lower layer has a flexible line extending therefrom, through the upper layer, and the upper layer has a clamp for releasably, securely receiving the flexible line, to permit the lower layer to present a downwardly-facing, generally concave surface.

10. Apparatus according to claim 5, wherein said raft comprises a system for causing said raft to assume the inflated state in said water body.

11. Apparatus according to claim 10, wherein the system comprises a supply of pressurized gas which is released to cause the raft to assume the inflated state.

12. Apparatus according to claim 11, wherein
the system comprises a valve system which automatically releases the pressurized gas when exposed to said water body; and
the valve system is positioned on the raft to permit it to be exposed to said water body when the raft is released from the raft holder.

13. Apparatus according to claim 12, wherein the raft holder has a rip cord for releasing the life raft.

14. Apparatus according to claim 2, wherein the raft holder is integrally connected to said survival suit.

15. Apparatus according to claim 12, wherein the cover section includes inner and outer conical walls, sealed to one another to form a bladder which, when inflated, caused the cover section to assume the conical shape.

16. Apparatus according to claim 15, wherein
the valve system comprises one or more valves, each of said one or more valves, in use, being immersed in the water body on the underside of the tube section;
each of said one or more valves forms part of a respective compressed gas inflator; and
a tube system is coupled to each of said one or more valves, the tube system including tubing which leads from said one or more valves to the interior of the tube section and to the bladder, the tubing having perforations through which the compressed gas enters the tube section and the bladder.

17. Apparatus according to claim 16, wherein each inflator is supported in use otherwise than by the valve so as to avoid fatigue at the seal which could otherwise result in leakage.

18. Apparatus according to claim 16, wherein each inflator includes a replaceable compressed gas canister.
